(19) United States
(12) Patent Application Publication
(10) Pub. No.: US 2026/0210498 A1
(43) Pub. Date: Jul. 23, 2026

(54) CRYOGENIC TANK CONTAINING AT LEAST ONE CRYOGENIC ELEMENT OF A HYDROGEN CIRCUIT, AIRCRAFT INCLUDING AT LEAST ONE SUCH TANK

(71) Applicant: Airbus Operations SAS, TOULOUSE (FR)

(72) Inventors: Umberto GASTALDI, TOULOUSE (FR); Thierry GACHES, TOULOUSE (FR); Matthieu MERLE, TOULOUSE (FR); Jean GELIOT, TOULOUSE (FR)

(21) Appl. No.: 19/385,612

(22) Filed: Nov. 11, 2025

(30) Foreign Application Priority Data
Nov. 19, 2024 (FR) FR2412659

(51) Int. Cl. F17C 13/00; F17C 1/12

(52) U.S. Cl. CPC F17C 13/001; F17C 1/12; F17C 2205/0196; F17C 2221/012; F17C 2260/033; F17C 2270/0186

(57) ABSTRACT

A cryogenic tank includes at least one enclosure, at least one cryogenic element located in the enclosure and at least one connecting system including at least one connecting element connecting first and second anchor points respectively rigidly attached to the enclosure and the cryogenic element directly or indirectly. The connecting element forms a thermal conduction path that has a length greater than a straight line distance separating the first and second anchor points.

### CROSS-REFERENCES TO RELATED APPLICATIONS

This application claims the benefit of the French Patent Application No. FR2412659 filed on Nov. 19, 2024, the entire disclosures of which are incorporated herein by way of reference.

### FIELD OF THE INVENTION

The present application relates to a cryogenic tank including at least one cryogenic element of a hydrogen circuit and to an aircraft including at least one such tank.

### BACKGROUND OF THE INVENTION

In one prior art embodiment, an aircraft hydrogen feed device includes at least one hydrogen tank and a plurality of hydrogen circuits each having at least one upstream end connected to the hydrogen tank and at least one downstream end connected, in particular, to at least one hydrogen engine or to at least one fuel cell.

Each hydrogen circuit includes pipes and equipment such as pumps, sensors, valves or exchangers, for example, interconnected by the pipes. The equipment and the pipes are positioned in at least one airtight cryogenic tank into which an inert gas is injected or in which a vacuum is produced. The equipment and/or the pipes in the cryogenic tank are connected to the latter by at least one connecting system.

In operation, the ambient temperature outside the cryogenic tank can vary between −50° C. and +100° C. while the temperature of the hydrogen in the equipment and the pipe must be between −253° C. and −235° C., depending on the pressure, so that the hydrogen remains in a liquid state.

Because of expansion phenomena induced by this temperature difference between the outside of the cryogenic tank and the hydrogen, each connecting system must be configured in such a manner as to limit the introduction of stresses at the level of the pipes and the equipment, which tends to complicate the design of the connecting system.

Moreover, because of its heat conducting properties, each connecting system causes an increase in the temperature of the hydrogen in the equipment and the pipe liable to cause a change of phase of the hydrogen.

The present invention aims to remedy some or all of the drawbacks of the prior art.

### SUMMARY OF THE INVENTION

To this end, the invention has for an object a cryogenic tank including at least one enclosure delimiting interior and exterior zones, at least one cryogenic element in the interior zone comprising a pipe, equipment or a cryogenic box containing a cryogenic element, at least one first anchor point rigidly attached to the enclosure, at least one second anchor point rigidly attached to the cryogenic element and at least one connecting system including at least one connecting element connecting the first and second anchor points, directly or indirectly.

According to the invention, the connecting element forms a thermal conduction path that has a length greater than a straight line distance separating the first and second anchor points.

This solution enables lengthening of the thermal conduction path between the first and second anchor points and thus reduction of thermal conduction between the outside of the enclosure and the cryogenic element.

In accordance with another feature, each connecting element includes at least one link having first and second ends, respectively connected to the first anchor point by at least one first articulation and to the second anchor point by at least one second articulation.

In accordance with another feature, the link includes a curve and/or a plurality of segments interconnected by at most two articulations.

In accordance with another feature, each link is positioned in a transverse plane, each articulation thereof having at least one pivot axis, the pivot axes of the articulations being parallel to one another and perpendicular to the transverse plane in which the link is positioned.

In accordance with another feature, at least one link includes a plurality of sections positioned end-to-end, at least one section being made of a first material, at least one other section being made of a second material, the first material having a lower thermal conductivity than the second material.

In accordance with another feature, the cryogenic tank includes at least one support, a first connecting system connecting the cryogenic element and the support, and a second connecting system connecting the support and the enclosure.

In accordance with another feature, the cryogenic element includes at least first and second rigid sections connected to different supports and at least one flexible section connecting the first and second rigid sections.

In accordance with another feature, the first connecting system includes at least one upright rigidly attached to the cryogenic element and at least one fixing system connecting the upright and the support.

In accordance with another feature, the fixing system includes thermal insulation between the upright and the support.

In accordance with another feature, the fixing system includes a shock absorbing element configured to allow slight relative movement between the upright and the support.

In accordance with another feature, the second connecting system includes at least one first pair of links comprising first and second links connecting the support and the enclosure and articulations connecting the first and second links to the support and to the enclosure, each articulation having at least one pivot axis.

In accordance with another feature, the second connecting system includes:
a pair of links comprising first and second links located in the same transverse plane, the pivot axes of the articulations being substantially parallel to one another and perpendicular to the first transverse plane, and
a fixed connection located in a second transverse plane separate from the first transverse plane.

In accordance with another feature, the second connecting system includes for each support:
a first pair of links comprising first and second links located in the same longitudinal plane, the pivot axes of the articulations of the first and second links of the first pair being substantially parallel to one another and perpendicular to the longitudinal plane, and
a second pair of links comprising first and second links located in first and second transverse planes, the pivot axes of the articulations of the first and second links of the second pair being substantially parallel to one another and perpendicular to the transverse planes.

In accordance with another feature, the first connecting system includes at least one fixing system connected to the support and located in a first transverse plane, the second connecting system including at least one articulation connecting it to the support and located in a second transverse plane offset relative to the first transverse plane.

In accordance with another feature, the cryogenic tank includes at least one cryogenic box located in the interior zone of the cryogenic tank and in which at least one cryogenic element is located.

In accordance with another feature, the cryogenic box includes at least two half-shells configured to occupy an assembled state in which the half-shells are connected and form a closed enclosure and a separated state in which the half-shells are separated and at least one locking/unlocking system configured to occupy a locked state in which it maintains the half-shells in the assembled state and an unlocked state in which it allows the half-shells to go from the assembled state to the separated state and vice versa.

In accordance with another feature, the cryogenic element located in the cryogenic box includes at least one first part in contact with a cryogenic fluid and at least one second part that is not in contact with the cryogenic fluid, the cryogenic element being entirely located in the cryogenic box.

In accordance with another feature, the cryogenic element located in the cryogenic box includes at least one first part in contact with a cryogenic fluid and at least one second part that is not in contact with the cryogenic fluid, the first part of the cryogenic element being located inside the cryogenic box, the second part of the cryogenic element being located outside the box.

In accordance with another feature, the cryogenic box contains a thermally-insulating material in which the cryogenic element is located.

The invention also has for an object an aircraft including at least one cryogenic tank having any of the foregoing features.

### BRIEF DESCRIPTION OF THE DRAWINGS

Other features and advantages will emerge from the following description of the invention given by way of example only with reference to the appended drawings, in which:

FIG. 1 is a schematic cross section of a cryogenic tank containing at least one element of a hydrogen circuit depicting one embodiment of the invention,

FIG. 2 is a schematic cross section of a cryogenic tank containing at least one cryogenic element of a hydrogen circuit depicting another embodiment of the invention,

FIG. 3 is a schematic longitudinal section of a cryogenic tank containing at least one cryogenic element of a hydrogen circuit depicting another embodiment of the invention,

FIG. 4 is a schematic cross section of a cryogenic tank containing at least one cryogenic element of a hydrogen circuit depicting another embodiment of the invention,

FIG. 5 is a perspective view of a part of cryogenic tank containing at least one cryogenic element of a hydrogen circuit depicting another embodiment of the invention,

FIG. 6 is a cross section of a part of the cryogenic tank seen in FIG. 5,

FIG. 7 is a schematic longitudinal section of a part of the cryogenic tank seen in FIG. 5,

FIG. 8 is a perspective view of a part of a cryogenic tank containing at least one cryogenic element of a hydrogen circuit depicting another embodiment of the invention,

FIG. 9 is a section taken along the line IX-IX in FIG. 8 of the cryogenic tank seen in FIG. 8,

FIG. 10 is a view from above of a connecting system connecting a support and an enclosure of the cryogenic tank seen in FIG. 8,

FIG. 11 is a schematic cross section of a cryogenic tank containing at least one cryogenic element of a hydrogen circuit depicting another embodiment of the invention,

FIG. 12 is a perspective view of a cryogenic tank containing at least one cryogenic element of a hydrogen circuit depicting another embodiment of the invention,

FIG. 13 is a perspective view of a cryogenic tank containing at least one cryogenic element of a hydrogen circuit depicting another embodiment of the invention.

### DETAILED DESCRIPTION OF THE PREFERRED EMBODIMENTS

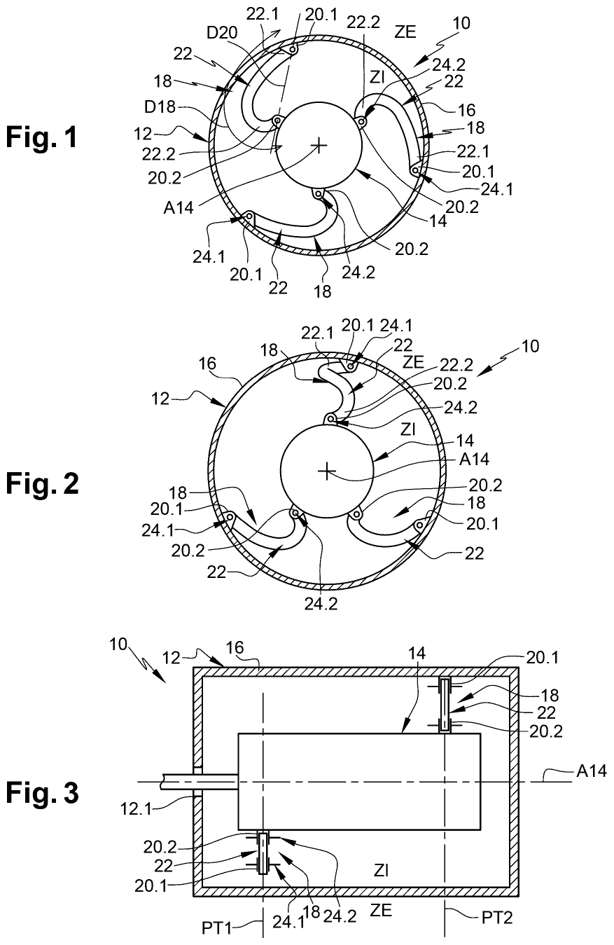

Embodiments of a cryogenic tank 10 seen in FIGS. 1 to 4 include at least one enclosure 12 delimiting interior and exterior zones ZI, ZE and at least one cryogenic element 14 positioned in the interior zone ZI comprising a pipe or equipment.

In one application, an aircraft includes at least one hydrogen feed device including at least one cryogenic tank 10.

The enclosure 12 is airtight. It contains an inert gas, for example helium or nitrogen, or a given vacuum that corresponds, for example, to a pressure level in the enclosure 12 at a pressure threshold chosen in the range 1×10-7 mbar to 10 mbar, according to the called for level of requirement.

The enclosure 12 is made of at least one rigid material. The enclosure 12 includes at least one orifice 12.1 passing through it configured to enable a cryogenic element 14, for example a pipe, to pass through it.

In one non-limiting configuration of the invention, the cryogenic element 14 extends along a longitudinal axis A14. In one arrangement, the enclosure 12 includes a lateral wall 16 that has an axis of revolution parallel to or coinciding with the longitudinal axis A14.

A longitudinal direction is parallel to the longitudinal axis A14. A longitudinal plane contains the longitudinal axis A14. A transverse plane is perpendicular to the longitudinal axis A14.

The cryogenic element 14 can be identical to those of a prior art hydrogen feed device.

The cryogen tank 10 includes at least one connecting system 18 that includes at least one first anchor point 20.1 rigidly attached to the enclosure 12, at least one second anchor point 20.2 rigidly attached to the cryogenic element 14, at least one link 22 that has first and second ends 22.1, 22.2 respectively connected to the first and second anchor points 20.1, 20.2, at least one first articulation 24.1 connecting the first anchor point 20.1 and the first end 22.1 of the link 22, and at least one second articulation 24.2 connecting the second anchor point 20.2 and the second end 22.2 of the link 22. The first and second anchor points 20.1, 20.2 are located on a straight line segment D20.

In accordance with one particular feature of the invention, the link 22 has a length D18 greater than a distance D20 measured along a straight line segment separating the first and second anchor points 20.1, 20.2, which makes it possible to increase the thermal conduction path between the first and second anchor points 20.1, 20.2 and thus to reduce thermal conduction between the outside of the enclosure 12 and the cryogenic element 14.

The link 22 includes a curve and/or a plurality of segments and does not follow the straight line segment D20 passing through the first and second anchor points 20.1, 20.2. The link 22, therefore, has a length D18 greater than the straight line distance D20 separating the first and second anchor points 20.1, 20.2. This configuration makes it possible to increase the thermal conduction path between the first and second anchor points 20.1, 20.2 and thus to reduce thermal conduction between the outside of the enclosure 12 and the cryogenic element 14.

In each connecting system 18 the link 22 and the first and second anchor points 20.1, 20.2 are located in a transverse plane.

The cryogenic tank 10 includes a plurality of connecting systems 18 located in the same transverse plane and/or a plurality of connecting systems 18 positioned in different transverse planes PT1, PT2 as depicted in FIG. 3.

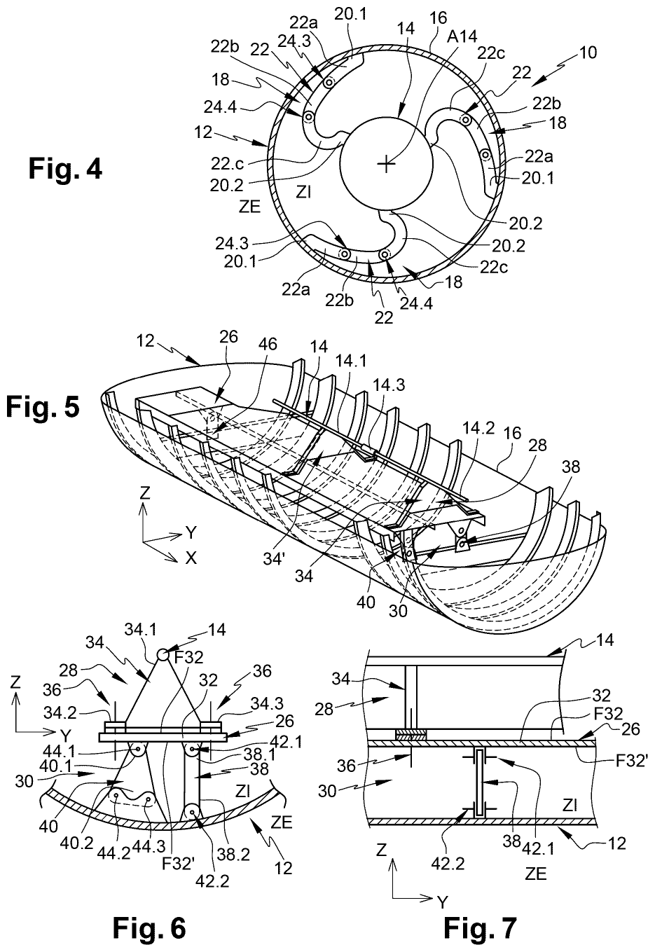

In one configuration, the link 22 is made in one piece as depicted in FIGS. 1 and 2 or comprises a plurality of sections 22a, 22b, 22c connected by at most two articulations as depicted in FIG. 4.

In a first configuration, the first section 22a is connected to the enclosure 12 at the first anchor point 20.1 by a fixed connection. The third section 22c is connected to the cryogenic element 14 at the second anchor point 20.2 by a fixed connection. The second section 22b is connected at its ends to the first and third sections 22a, 22c by two intermediate articulations 24.3, 24.4.

In a second configuration, the first section 22a is connected to the enclosure 12 at the first anchor point 20.1 by a first articulation 24.1. The third section 22c is connected to the cryogenic element 14 at the second anchor point 20.2 by a second articulation 24.2. The second section 22b is connected at its ends to the first and third sections 22a, 22c by fixed connections.

Of course the invention is not limited to these first and second configurations.

In different variants the link 22 is made of the same material or of different materials that have different characteristics, in particular in terms of thermal conduction. Thus, as depicted in FIG. 4 at least one link 22 comprises a plurality of sections 22a, 22b, 22c positioned end-to-end, at least one section 22b being made of a first material, at least one other section 22a, 22c being made of a second material, the first material having a lower thermal conductivity than the second material.

In one embodiment, at least one of the articulations 24.1 to 24.4 includes at least one pivot axis. In one configuration, at least one of the articulations 24.1 to 24.4 is a universal joint type connection and allows pivoting about three orthogonal pivot axes. For at least one link 22 the pivot axes of the articulations 24.1 to 24.4 are parallel to one another and perpendicular to the transverse plane in which the link 22 is located.

In any of the embodiments, the links 22 and the articulations 24.1 to 24.4 are configured to obtain an isostatic connection between the cryogenic element 14 and the enclosure 12, limiting the transmission of stresses between the cryogenic element 14 and the enclosure 12.

In embodiments seen in FIGS. 5 to 10, the cryogenic tank 10 includes at least one support 26, a first connecting system 28 connecting the cryogenic element 14 and the support 26, and a second connecting system 30 connecting the support 26 and the enclosure 12.

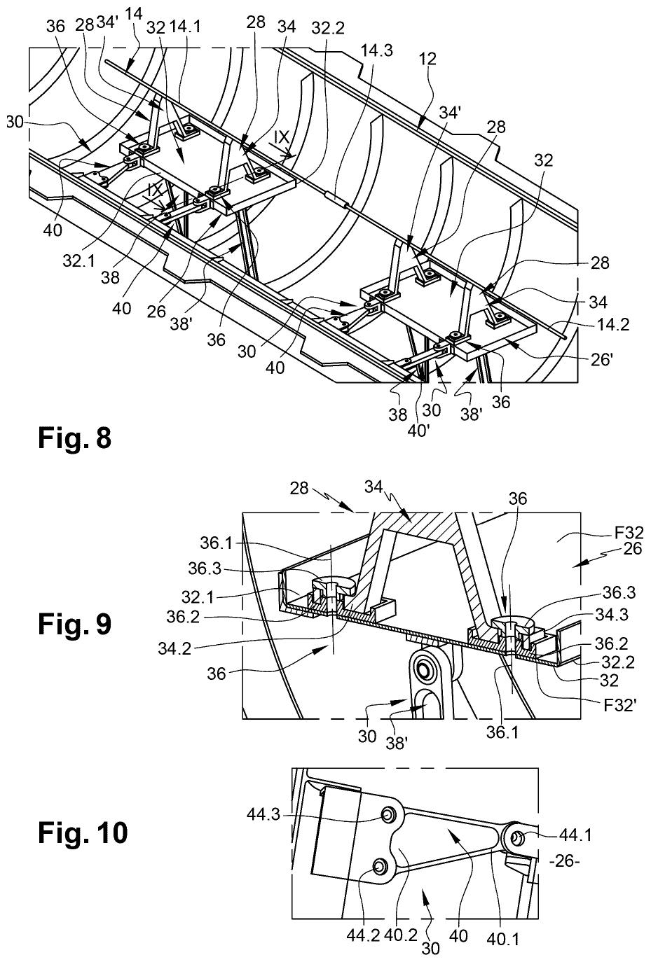

In a first variant seen in FIG. 5, the cryogenic tank 10 includes a single support 26. In a second variant seen in FIG. 8, the cryogenic tank 10 includes a plurality of supports 26, 26′ spaced from one another and distributed along the longitudinal axis X.

In one configuration, at least one support 26, 26′ includes a plate 32 that has opposite first and second faces F32, F32′ and lateral sides 32.1, 32.2 parallel to the longitudinal axis X, for example.

In an embodiment seen, in particular, in FIGS. 6, 7 and 9, the first connecting system 28 includes at least one upright 34, for example of triangular shape, that has an apex 34.1 (corresponding to the second anchor point 20.2) rigidly attached to the cryogenic element 14 and first and second lugs 34.2, 34.3 located at each end of the side opposite the apex 34.1 of triangular shape of the upright 34. The apex 34.1 and the first and second lugs 34.2, 34.3 are located in a transverse plane. Complementing this, the first connecting system 28 includes at least one fixing system 36 connecting the upright 34, to be more precise each of the first and second lugs 34.2, 34.3, and the support 26, 26′. In one arrangement, the first and second lugs 34.2, 34.3 are in contact with or at a small distance from the first face F32 of the latter. In one variant, at least one upright 34 is an element separate from the cryogenic element 14. In other variants, at least a part of the upright 34 is a part of the cryogenic element 14.

In an embodiment shown in detail in FIG. 9, the fixing system 36 includes at least one bolt 36.1 (schematically represented by a chain-dotted line) passing through the upright 34, to be more precise each lug 34.2, 34.3, and the support 26, 26′ and at least one thermally-insulating element 36.2, such as a ring, for example, between the upright 34, to be more precise each lug 34.2, 34.3, and the support 26, 26′. In one configuration, the fixing system 36 includes a shock-absorbing element 36.3 between the bolt 36.1 and the lug 34.2, 34.3 configured to allow a small relative movement between the upright 34 and the support 26, 26′. This shock-absorbing element 36.3 is configured as a function of the amplitude and/or the direction of the required relative movement between the upright 34 and the support 26, 26′. Of course, the invention is not limited to this embodiment of the fixing system 36. The latter must make it possible to obtain an isostatic assembly while enabling control of the position of the cryogenic element 14 without introducing stresses. Thus, at least one fixing system 36 need not allow relative movement, at least one fixing system 36 may allow relative movement in only one direction in the presence a through-hole of oblong shape to house the shank of the bolt 36.1, and/or at least one fixing system 36 may allow relative movement in more than one direction in the presence of a through-hole to house the shank of the bolt 36.1 that has a diameter greater than that of the shank of the bolt 36.1.

In one arrangement, the first connecting system 28 includes a plurality of parallel uprights 34, 34′ located in a plurality of transverse planes.

In an embodiment seen in FIG. 8, the cryogenic element 14 includes at least first and second rigid sections 14.1, 14.2 connected to different supports 26, 26′ and at least one flexible section 14.3 connecting the first and second rigid sections 14.1, 14.2.

In one non-limiting embodiment of the invention, the second connecting system 30 includes at least one first pair of links comprising first and second links 38, 40 connecting the support 26, 26′ and the enclosure 12. As depicted in detail in FIG. 6, the first link 38 is a two-point link that has a first end 38.1 connected by a first articulation 42.1 to the support 26, 26′, to be more specific to the second face F32′ of the support 26, 26′, and a second end 38.2 connected by a second articulation 42.2 to the enclosure 12, to be more specific to a first anchor point rigidly attached to the enclosure 12; the first and second articulations 42.1, 42.2 each have at least one pivot axis, the pivot axes of the first and second articulations 42.1, 42.2 being substantially parallel to one another. The second link 40 is a three-point link that has a first end 40.1 connected by a first articulation 44.1 to the support 26, 26′, to be more specific to the second face F32′ of the support 26, 26′, and a second end 40.2 connected by second and third articulations 44.2, 44.3 to the enclosure 12, to be more specific to first and second anchor points rigidly attached to the enclosure 12; the first, second and third articulations 44.1, 44.2, 44.3 each have at least one pivot axis, the pivot axes of the first, second and third articulations 44.1, 44.2, 44.3 being substantially parallel to one another. Of course, the invention is not limited to this embodiment of the second connecting system 30.

In a first arrangement visible in FIGS. 5 and 6, the second connecting system 30 includes a two-point first link 38 and a three-point second link 40 located in the same first transverse plane, the pivot axes of the first, second and third articulations 42.1, 42.2, 44.1, 44.2, 44.3 being substantially parallel to one another and perpendicular to the first transverse plane. Complementing this, the second connecting system 30 includes a fixed connection 46 located in a second transverse plane separate from the first transverse plane.

In a second arrangement seen in FIGS. 8 to 10, the second connecting system 30 includes for each support 26, 26′ a first pair of links comprising first and second links 38, 40 located in the same longitudinal plane substantially coplanar with the plate 32 of the support 26, 26′, the pivot axes of the first, second and third articulations 42.1, 42.2, 44.1, 44.2, 44.3 of the first and second links of the first pair being substantially parallel to one another and perpendicular to the longitudinal plane. The first and second links 38, 40 of the first pair are connected to one of the lateral sides 32.1, 32.2 of the plate 32 of the support 26, 26′. Complementing this, the second connecting system 30 includes for each support 26, 26′ a second pair of links comprising first and second links 38′ 40′ located in first and second transverse planes, the pivot axes of the first, second and third articulations of the first and second links of the second pair being substantially parallel to one another and perpendicular to the transverse planes.

Of course, the invention is not limited to these embodiments of the first and second connecting systems 28, 30. In any embodiment, the first and second connecting systems 28, 30 are configured to produce an isostatic connection between the cryogenic element 14 and the enclosure 12, limiting the transmission of stresses between the cryogenic element 14 and the enclosure 12. In a preferred configuration, the first, second and third links 38, 38′, 40, 40′ are as long as possible so as to increase the thermal conduction path between the enclosure 12 and the cryogenic element 14.

In one embodiment, in the presence of a support 26, 26′ the first connecting system 28 includes at least one fixing system 36 connected to the support 26, 26′ located in a first transverse plane, the second connecting system 30 including at least one articulation 42.1, 42.2, 44.1, 44.2, 44.3 connecting it to the support 26, 26′ located in a second transverse plane offset along the longitudinal axis X relative to the first transverse plane. This arrangement contributes to increasing the length of the thermal conduction path between the first anchor points rigidly attached to the enclosure 12 and the second anchor points rigidly attached to the cryogenic element 14.

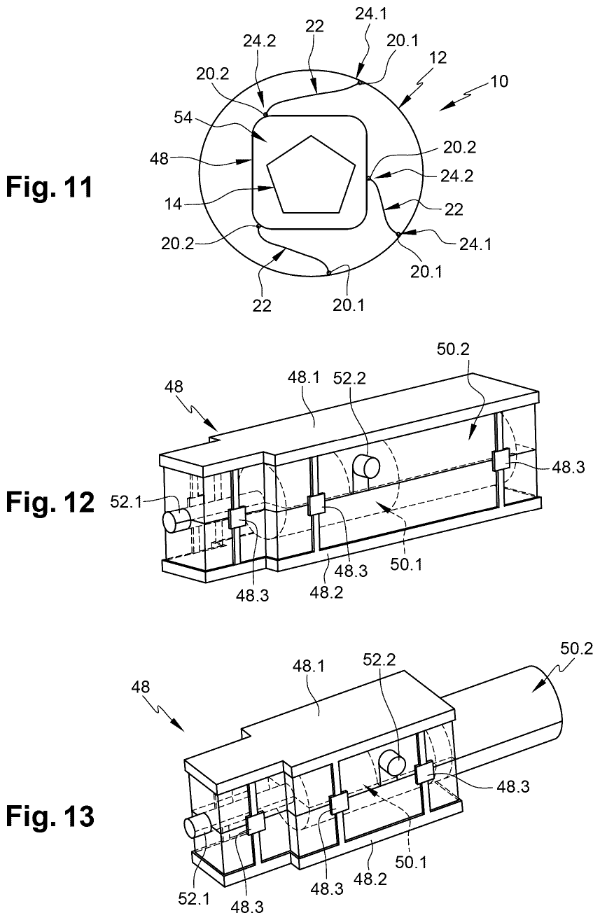

In other embodiments seen in FIGS. 11 to 13, the cryogenic tank 10 includes at least one cryogenic box 48 located in the interior zone ZI of the cryogenic tank 10 in which at least one cryogenic element 14 is located. These embodiments are more particularly suitable for cryogenic elements 14 of high mass.

In one configuration, the cryogenic box 48 includes at least two half-shells 48.1, 48.2 configured to occupy an assembled state in which they are connected and form a closed enclosure and a separated state in which they are separated and at least one locking/unlocking system 48.3 configured to occupy a locked state in which it maintains the half-shells 48.1, 48.2 in the assembled state and an unlocked state in which it allows the half-shells 48.1, 48.2 to go from the assembled state to the separated state and vice versa.

The cryogenic box 48 is made of at least one thermally-insulating material.

The cryogenic box 48 is connected to the enclosure 12 by links 22 like the cryogenic element 14 seen in FIGS. 1 to 4 or by links 38, 38′, 40, 40′ like the support or supports 26, 26′ seen in FIGS. 5 to 10.

In one embodiment, the cryogenic element 14 in the cryogenic box 48 includes at least one first part 50.1, for example a pump, in contact with a cryogenic fluid and at least one second part 50.2 that is not in contact with the cryogenic fluid, such as a motor, for example.

In a first configuration seen in FIG. 12, the cryogenic element 14 (to be more specific its first and second parts 50.1, 50.2) is located entirely inside the cryogenic box 48.

In a second configuration seen in FIG. 13, only the first part 50.1 of the cryogenic element 14 is located inside the cryogenic box 48, the second part 50.2 of the cryogenic element 14 being located outside the box 48.

In one embodiment, the cryogenic box 48 includes at least one orifice 52.1 passing through at least one of the two half-shells 48.1, 48.2. In one configuration the cryogenic box 48 includes at least one first orifice 52.1 configured to house a first cryogenic fluid pipe and at least one second orifice 52.2 configured to house a second cryogenic fluid pipe.

In one embodiment, the cryogenic element 14 in the cryogenic box 48 is connected to the latter by at least one connecting system configured to limit thermal transfer and the transmission of stresses between the cryogenic element 14 and the cryogenic box 48. In particular, the connecting system corresponds, in part or in whole, to the cryogenic box 48 itself. In one embodiment, the cryogenic box 48 surrounds the cryogenic element with which it is in contact with no intermediate connection.

In one configuration, the cryogenic box 48 contains a thermally-insulating material 54 in which the cryogenic element 14 is located. This thermally-insulating material 54 can be a foam material.

In any embodiment, the cryogenic tank 10 includes at least one enclosure 12 delimiting interior and exterior zones ZI, ZE and at least one cryogenic element 14 in the enclosure 12. This cryogenic element 14 can be a pipe in which a cryogenic fluid circulates, equipment in contact with a cryogenic fluid, such as a pump for example, or a cryogenic box containing an element in contact with a cryogenic fluid. The cryogenic tank 10 also includes at least one first anchor point 20.1 rigidly attached to the enclosure 12, at least one second anchor point 20.2 rigidly attached to the cryogenic element 14 and at least one connecting system 18, 28, 30 including at least one connecting element such as a link 22, 38, 38′, 40, 40′ connecting the first and second anchor points 20.1, 20.2 directly or indirectly. The connecting element forms a thermal conduction path that has a length D18 greater than a straight line distance D20 separating the first and second anchor points 20.1. This solution makes it possible to increase the length D18 of the thermal conduction path between the enclosure 12 and the cryogenic element 14.

Configurations of the cryogenic tank 10 include a plurality of connecting elements each including a link 22 that has first and second ends 22.1, 22.2 respectively connected to the first and second anchor points 20.1, 20.2.

In other configurations, the cryogenic tank 10 includes at least one support 26, 26′, a first connecting system 28 connecting the cryogenic element 14 and the support 26, 26′, and a second connecting system 30 connecting the support 26 and the enclosure 12. The first connecting system 28 includes at least one connecting element such as an upright 34 connected on the one hand to the cryogenic element, to be more specific to at least one first anchor point 20.2 rigidly attached to the cryogenic element, and on the other hand to the support 26, 26′. The second connecting system 30 includes a plurality of connecting elements such as links 38, 38′, 40 and 40′ each connected, on the one hand, to the support 26, 26′ and, on the other hand, to the enclosure 12, to be more specific to at least one first anchor point 20.1 rigidly attached to the enclosure 12.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A cryogenic tank comprising:
at least one enclosure delimiting interior and exterior zones,
at least one cryogenic element in the interior zone comprising a pipe, equipment or a cryogenic box containing a cryogenic element,
at least one first anchor point rigidly attached to the at least one enclosure,
at least one second anchor point rigidly attached to the cryogenic element, and
at least one connecting system comprising at least one connecting element connecting the at least one first and second anchor points directly or indirectly, the connecting element forming a thermal conduction path that has a length greater than a straight line distance separating the first and second anchor points,
at least one support,
a first connecting system connecting the cryogenic element and the at least one support, and
a second connecting system connecting the support and the enclosure,
wherein the cryogenic element comprises at least first and second rigid sections connected to different supports and at least one flexible section connecting the first and second rigid sections.

2. The cryogenic tank as claimed in claim 1 wherein the first connecting system comprises at least one upright rigidly attached to the cryogenic element and at least one fixing system connecting the upright and the support.

3. The cryogenic tank as claimed in claim 2 wherein the fixing system comprises thermal insulation between the upright and the support.

4. The cryogenic tank as claimed in claim 2 wherein the fixing system comprises a shock absorbing element configured to allow slight relative movement between the upright and the support.

5. The cryogenic tank as claimed in claim 1 wherein the second connecting system comprises at least one first pair of links comprising first and second links connecting the support and the enclosure, and articulations connecting the first and second links to the support and to the enclosure, each articulation having at least one pivot axis.

6. The cryogenic tank as claimed in claim 5 wherein the second connecting system comprises:
a pair of links comprising first and second links located in a same transverse plane, pivot axes of the articulations being substantially parallel to one another and perpendicular to a first transverse plane, and
a fixed connection located in a second transverse plane separate from the first transverse plane.

7. The cryogenic tank as claimed in claim 5 wherein the second connecting system comprises for each support:
a first pair of links comprising first and second links located in a same longitudinal plane, pivot axes of the articulations of the first and second links of the first pair being substantially parallel to one another and perpendicular to the longitudinal plane, and
a second pair of links comprising first and second links located in first and second transverse planes, pivot axes of the articulations of the first and second links of the second pair being substantially parallel to one another and perpendicular to the transverse planes.

8. The cryogenic tank as claimed in claim 1 wherein the first connecting system comprises at least one fixing system connected to the support and located in a first transverse plane, the second connecting system comprising at least one articulation connecting the second connecting system to the support and located in a second transverse plane offset relative to the first transverse plane.

9. The cryogenic tank as claimed in claim 1 wherein the cryogenic tank comprises at least one cryogenic box located in an interior zone of the cryogenic tank and in which at least one cryogenic element is located.

10. The cryogenic tank as claimed in claim 9 wherein the cryogenic box comprises at least two half-shells configured to occupy an assembled state in which the half-shells are connected and form a closed enclosure, and a separated state in which the half-shells are separated, and at least one locking/unlocking system configured to occupy a locked state in which the at least one locking/unlocking system maintains the half-shells in the assembled state and an unlocked state in which the at least one locking/unlocking system allows the half-shells to go from the assembled state to the separated state and vice versa.

11. The cryogenic tank as claimed in claim 9 wherein the cryogenic element located in the cryogenic box comprises at least one first part in contact with a cryogenic fluid and at least one second part that is not in contact with the cryogenic fluid, the cryogenic element being entirely located in the cryogenic box.

12. The cryogenic tank as claimed in claim 9 wherein the cryogenic element located in the cryogenic box comprises at least one first part in contact with a cryogenic fluid and at least one second part that is not in contact with the cryogenic fluid, the first part of the cryogenic element being located inside the cryogenic box, the second part of the cryogenic element being located outside the box.

13. The cryogenic tank as claimed in claim 9 wherein the cryogenic box contains a thermally-insulating material in which the cryogenic element is located.

14. A cryogenic tank comprising:
at least one enclosure delimiting interior and exterior zones,
at least one cryogenic element located in the interior zone comprising a pipe, equipment or a cryogenic box containing a cryogenic element,
at least one first anchor point rigidly attached to the at least one enclosure,
at least one second anchor point rigidly attached to the cryogenic element, and
at least one connecting system comprising at least one connecting element connecting the at least one first and second anchor points directly or indirectly, in which tank the connecting element forms a thermal conduction path that has a length greater than a straight line distance separating the first and second anchor points,
wherein the cryogenic tank comprises at least one cryogenic box located in the interior zone of the cryogenic tank in which at least one cryogenic element is located, and
wherein the cryogenic element located in the cryogenic box comprises at least one first part in contact with a cryogenic fluid and at least one second part that is not in contact with the cryogenic fluid.

15. The cryogenic tank as claimed in claim 14 wherein the cryogenic element is entirely located in the cryogenic box.

16. The cryogenic tank as claimed in claim 14 wherein the first part of the cryogenic element is located inside the cryogenic box and the second part of the cryogenic element is located outside the box.

17. An aircraft comprising at least one cryogenic tank as claimed in claim 1.
